(19) United States
(12) Patent Application Publication
(10) Pub. No.: US 2013/0266372 A1
(43) Pub. Date: Oct. 10, 2013

(54) Subsurface Insulation Product and Method for Installing Same

(71) Applicant: John BANDURA, Rocky Mountain House (CA)

(72) Inventor: John BANDURA, Rocky Mountain House (CA)

(73) Assignees: Bernice Bandura, Rocky Mountain House (CA); John Bandura, Rocky Mountain House (CA)

(21) Appl. No.: 13/441,236

(22) Filed: Apr. 6, 2012

(51) Int. Cl. E02D 3/00; E01C 23/10; F16L 57/00; E02D 3/11; E02D 3/12

(52) U.S. Cl. 404/75; 405/130; 405/258.1; 405/266; 405/157

(57) ABSTRACT

A subsurface thermal insulation product for reducing ground disturbance during a freeze-thaw cycle comprises: a plurality of thermal insulation panels each comprising: a foam board and a water wicking sheet attached to one of the top surface or the bottom surface of the foam board. Each foam board has a top surface and a bottom surface and four peripheral shiplap edges each with a notch that permits multiple thermal insulation panels to be placed in adjacent overlapping engagement.

### FIELD

The present invention relates to a subsurface insulation product that reduces ground disturbance during freeze-thaw cycles, and a method for installing same to protect a road or other ground infrastructure.

### BACKGROUND

Freeze-thaw cycles may result in frost heaves or frost boos, both of which damage roads and other infrastructure, such as buried utility lines.

A frost boil is caused by capillary action of water during freeze-thaw cycles. The capillary action draws dirt long with the water, creating a subsurface cavity which undermines and leads to damage and ultimately the collapse of a road.

A frost heave is caused by absorbent soils. Soils, such as bentonite clay, are capable of absorbing large amounts of water. As the water freezes it expands, pushing the soil underlying a road upwardly and damaging the road.

One approach to reducing ground disturbances during freeze-thaw cycles is disclosed in Canadian patent CA 2,377,702. This patent discloses a method which includes the steps of laying a subsurface layer of thermal insulation over an affected area, thereby thermally insulating the affected area from freezing, and laying a subsurface layer of wick material capable of drawing water away from the affected area by capillary action parallel to the subsurface layer of thermal insulation and positioned in a path of the subsurface flow of water.

It is desirable to provide improvements to present approaches of reducing such ground disturbances during freeze-thaw cycles.

### SUMMARY

According to one aspect of the invention, there is provided a subsurface thermal insulation product for reducing ground disturbance during a freeze-thaw cycle. The product comprises a plurality of interlocking thermal insulation panels. Each panel comprises a foam board and a water wicking sheet attached to one of the top surface or the bottom surface of the foam board. Each foam board has a top surface and a bottom surface and four peripheral shiplap edges each with a notch that permits multiple thermal insulation panels to be placed in adjacent overlapping engagement, The product can also include a water-repelling sheet attached to the other of the top surface and bottom surface of the thermal insulation panels; this water-repelling sheet is useful to direct water away from the panels. Each insulation panel can be composed of a foam material such as polystyrene. The insulation panel range from 3″-4″ thick and the notches can extend from the side edges, i.e. have an overlap of 2.7′ to 3.3″, and in particular have an overlap of 3″. The ratio of board thickness to overlap can be between 1.48:1 and 1.21:1 to provide superior breakage resistance.

The thermal insulation panels are provided to reduce the likelihood of freezing in the temperature ranges at which freeze-thaw cycles normally occur. The wicking sheet is also provided to draw water away from the affected area by capillary action. Thus, water is moved away from the affected area so that there is less likelihood of ground disturbance should the affected area freeze.

Although beneficial results may be obtained through the use of the subsurface insulation product as described above, water coming from secondary sources (such as an artisian spring) and other directions can be confined by placing a water repelling sheet attached-bonded to the other of the top surface or the bottom surface.

Although beneficial results may be obtained through the use of the thermal insulation panel, as described above, when covering large areas, such as underlying multi-lane highways, it is difficult to do so using a single panel. It may therefore be necessary to use multiple panels. However, the object of containing and redirecting the water could be defeated by water seeping around the panels. It is, therefore, preferred that the panels have notches along all four peripheral side edges to enable the insulation panels to be placed in side by side overlapping engagement.

### BRIEF DESCRIPTION OF THE DRAWINGS

FIGS. 1(a) and (b) are end elevation views, in section, of a road having with an affected area which has been repaired with a subsurface insulation product according to a first embodiment (FIG. 1(a)) and a second embodiment (FIG. 1(b)) of the invention, respectively.

FIG. 2 is a perspective view, partially cut away, of a road and a plurality of insulation panels of the subsurface insulation product according to the second embodiment.

FIGS. 3(a) and (b) are exploded bottom end and top end perspective views of part of the first and second embodiments of the subsurface insulation product.

FIGS. 4(a) to (d) are respective top plan, side elevation, bottom plan, and end elevation views of the insulation panels of the first and second embodiments of the subsurface insulation product.

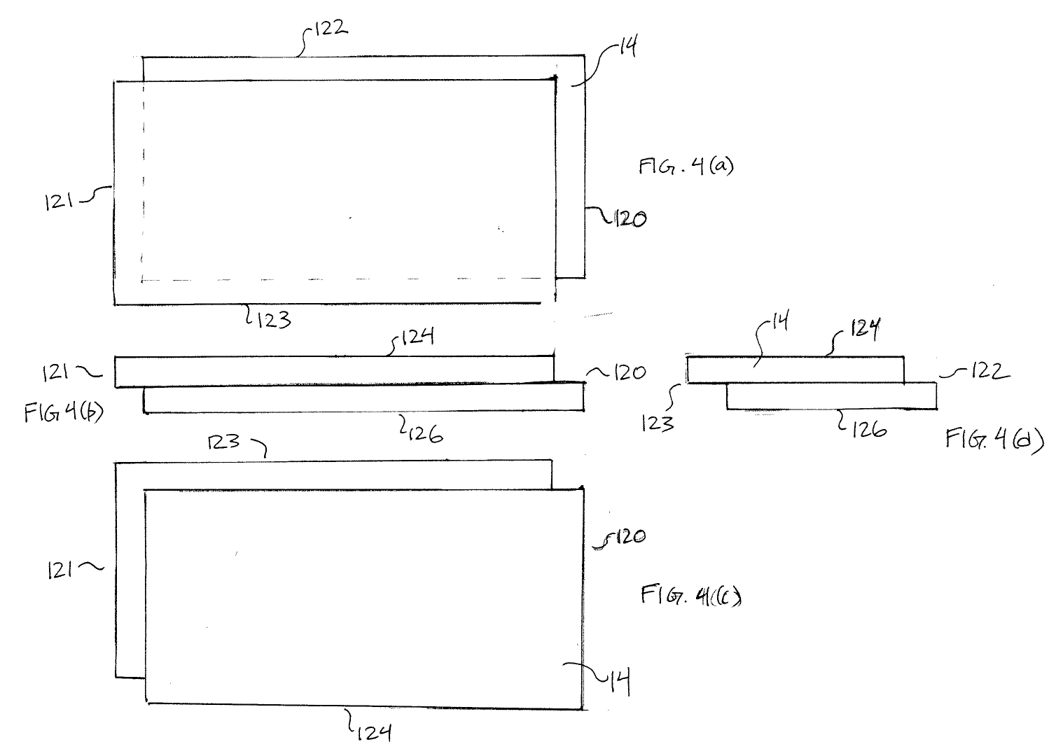

FIG. 5 is a top perspective of three adjacent insulation panels of the first and second embodiments of the product.

FIG. 6 is a detailed top perspective view of connections between two adjacent insulation panels of the first and second embodiments of the product.

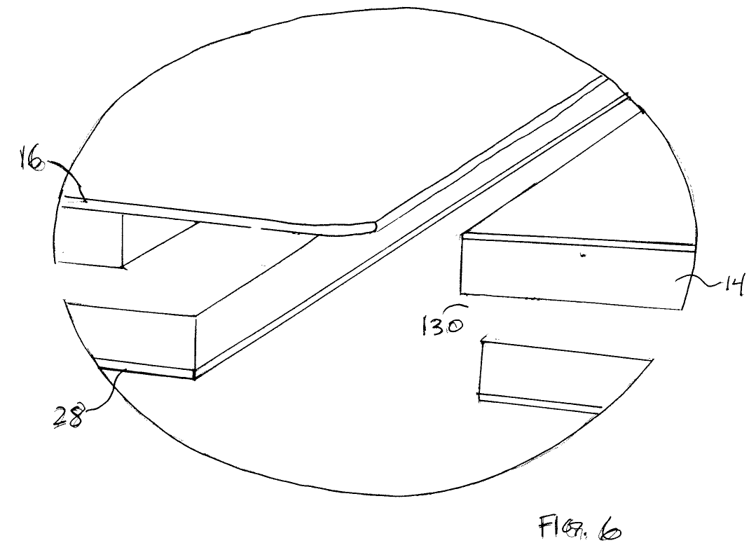

### DETAILED DESCRIPTION

The embodiments of the invention described herein relate to a subsurface insulation product used to reduce ground disturbance of ground infrastructure during a freeze-thaw cycle, and a method for installing such a product to protect the ground infrastructure. Examples of ground infrastructure that can be protected by the insulation product include foundations, surface and subsurface pipelines, roadways, and sewer lines.

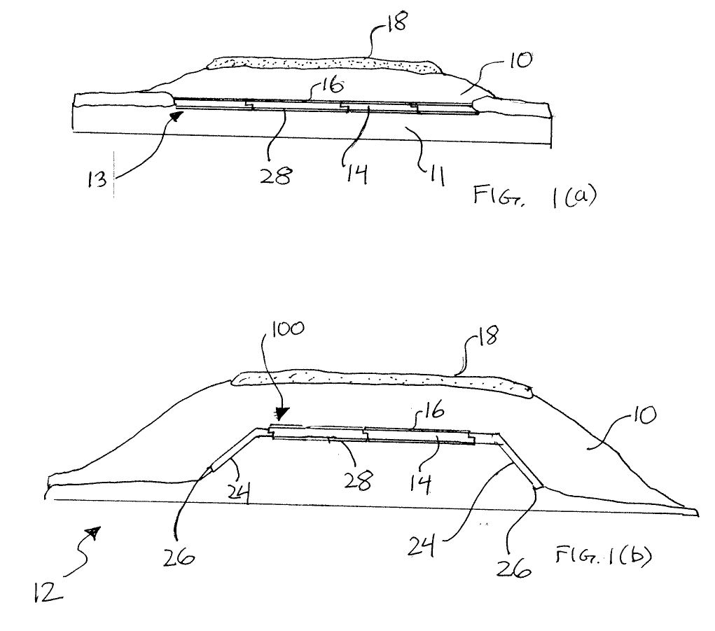

A first embodiment of the subsurface insulation product comprising a plurality of interlocking thermal insulation panels 13 is shown in FIG. 1(a) and which is installed under a road located in a permafrost area. A second embodiment is shown in FIG. 1(b) wherein the subsurface insulation product includes the thermal insulation panels 13 and angled wings 24 and which is installed in an elevated roadway. In both embodiments, each interlocking thermal insulation panel 13 is generally planar and comprises a foam board 14 with means for interlocking with adjacent insulation panels 13 around all four peripheral edges of the foam board 14, a water wicking sheet 16 attached to and covering a major surface of each foam board 14 and that is capable of drawing water away from an affected area 12 by capillary action, and a water repelling sheet 28 attached to and covering the other major surface of each foam board 14 and that provides a water incursion barrier. As will be described in further detail below, the position of the water wicking sheet 16 and water repelling sheet 28 when installed in the ground is dependent on the direction in which the water or moisture originates.

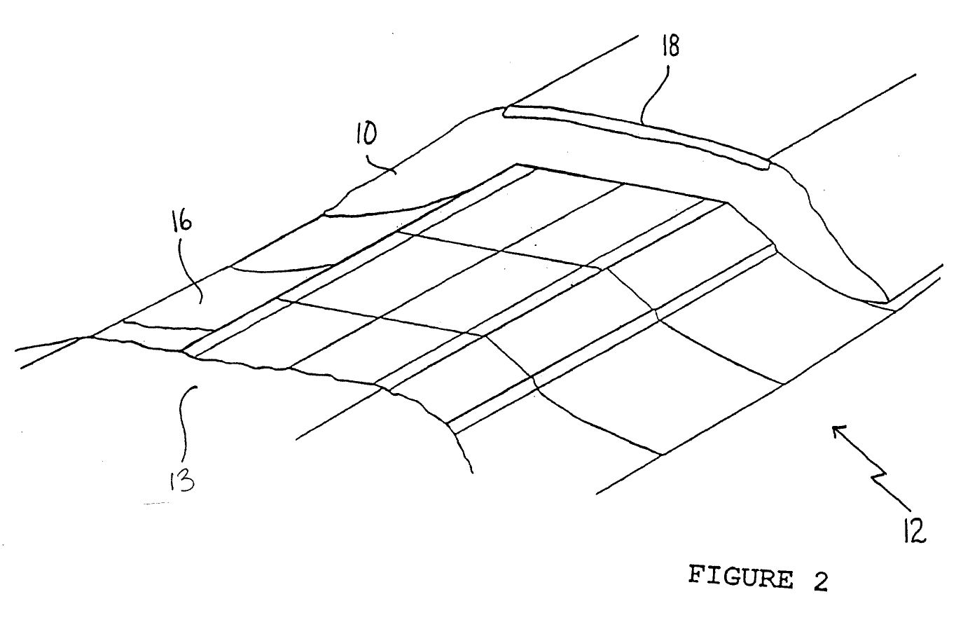

In the second embodiment shown in FIGS. 1(b) and 2, the insulation panels 13 are installed under an elevated roadway and interlock with a plurality of downwardly angled wings 24. The downwardly angled wings 24 prevent frost penetration from peripheral edges 26 of the insulation product, When this embodiment is installed in the manner as shown in these Figures, the panels 13 are oriented so that the water wicking sheets 16 are positioned in a path of the subsurface flow of water. In this case, the water wicking sheets 16 are facing upwards and covering the top surface of the foam board 14 and the water repelling sheets are covering the bottom surface of the foam board 14. Soil 10 is then replaced over the water wicking sheets 16. After the soil 10 is replaced, the affected area 12 can then be repaved with travel surface 18. In operation, the water wicking sheets draw water originating from the source of water above the subsurface insulation product 100 and towards the foam board 14; this water then flows along the foam board 14 to its edges and then is directed by the water repelling layer 28 to a drainage area away from the roadway 18.

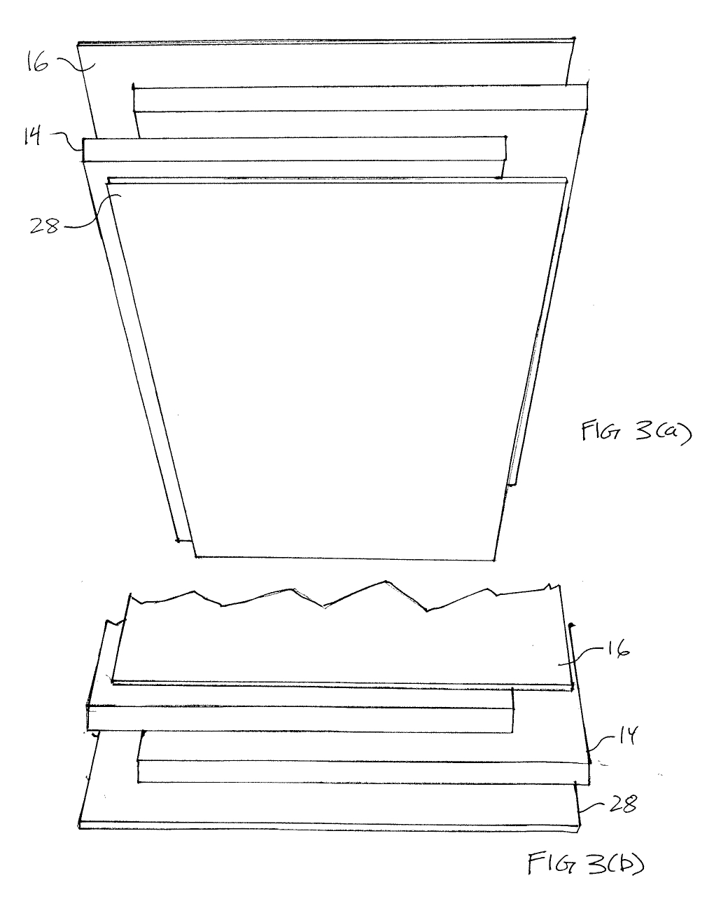

The subsurface insulation product will now be described in greater detail with reference to FIGS. 3(a)-(b) to 5. Both embodiments of the insulation product comprise panels 13 having a generally planar thermally insulating foam board 14 sandwiched by one or more of the water wicking sheets 16 and one or more of the water repelling sheets 28. In the second embodiment, the product also includes one or more thermally insulating angled wings 24.

Each foam board 14 is in the form of a single rigid planar and rectangular board. The foam board 14 can be composed of high density expanded polystyrene (EPS), such as the closed cell EPS foam insulation sheets made by Plasti-Fab™ under the trade-mark PlastiSpan®. This EPS foam insulation sheet meets or exceeds the requirements of the Canadian standard CAN/ULC-S701-05 Standard for Thermal Insulation Styrene, Boards and Pipe Covering. Other suitable foam sheets include high strength EPS foam insulation boards manufactured by Beaver Plastics™ under the trade-mark Terrafoam HS-40® also meets or exceeds CAN/ULCS-701 type 2 standard as well as the ASTM C-578 Type 14 standard by the American Society for Testing and Materials. Other suitable foam sheets 14 are provided by Dow under the SM™ and SM Hi Load™ trade-marks. Alternatively, the foam board 14 can be made from another insulating foam material such as polyurethane.

In this embodiment, each foam board 14 is about four feet (4′) wide by eight feet (8′) long by four inches (4″) thick; however, the foam board 14 can be produced in other dimensions depending on the preferences of the user. For example, the board 14 can be between 3″ to 4″ thick, The foam board 14 has a top surface 124 and a bottom surface 126 and four notched or “shiplap” peripheral edges, namely, first and second opposed short shiplap edges 120, 121, and third and fourth opposed long shiplap edge 122, 123. The first short shiplap edge 120 has a notch extending outwardly from the bottom half of the edge 120 and along its entire length. The second short shiplap edge 121 has a notch extending outwardly from the top half of the shiplap edge 121 and along its entire length. Similarly, the third long shiplap edge 122 has a notch extending outwardly from the bottom half of the shiplap edge 122 and along its entire length, and the fourth long shiplap edge 123 has a notch extending outwardly from the top half of the edge 123 and along its entire length. The net impression created by these four shiplap edges is of two offset sheets that are fused together, as evident from the Figures, even though the board 14 is made from a single piece.

While the foam board 14 is formed by extruding a single piece of polystyrene material and cutting the four notched shiplap edges 120, 121, 122, 123 into the board 14 in the configuration described above, the foam board 14 can be alternatively formed from a pair of sheets (not shown) joined together in an offset manner.

In this embodiment, the notches for the first and second short shiplap edges 120, 121 and the third and third long shiplap edges 122, 123 extend 3″ (about 75 mm) outwards and 4 feet along the length of the respective shiplap edges 120, 121, i.e. has a 3 inch “overlap”. This overlap dimension has been found to provide superior resistance to breakage relative to the material and dimensions of the sheet 118, particularly the sheet's thickness. It is expected that an overlap of between 2.7″ and 3.3″ (about 70 and 85 mm) for a 4 inch thick EPS foam board 14 (and each notch being ½ the thickness of the board at 2″) will provide similar superior breakage resistance. To put it another way, an EPS board 14 should have a ratio of board thickness to overlap of between 1.48:1 and 1.21:1 to provide superior breakage resistance.

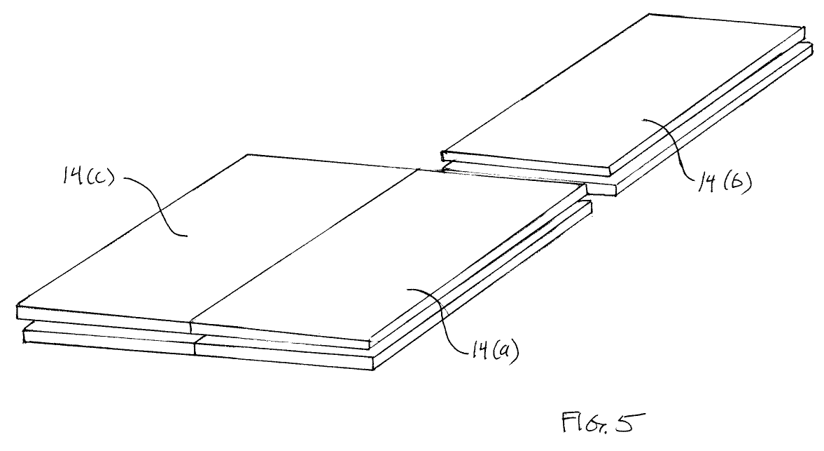

The notched shiplap edges 120, 121, 122, 128 allow each thermal insulation panel 13 to overlap or “interlock” with adjacent and similarly configured thermal insulation panels 13. Referring to FIG. 5 as an example, the second short shiplap edge 121 of a first foam board (shown as 14(a) in this Figure) can mate with the first short shiplap edge of a second foam board (shown as 14(b) in this Figure), and the fourth shiplap edge 123 of the first thermal insulation panel 13(a) can mate with the third shiplap edge of a third foam board (shown as 14(c) in this Figure).

Referring again to FIGS. 3(a) and (b), the water wicking sheet 16 is made of a non-woven geosynthetic fabric which is capable of drawing water away from an affected area by capillary action is attached to and covers the top surface 124 of the foam board 14 and extends slightly past the first short shiplap edge 120. The water repelling sheet 28 is made of a woven geosynthetic fabric which is attached to and covers the bottom surface 126 of the foam board 14, such as woven geosynthetic fabric 9852 manufactured by Nilex™. Each of these sheets 16, 28 can be attached by staples, or by an adhesive such as a foam adhesive such as those manufactured by 3M™. Attaching these sheets 16, 28 to the board 14 significantly enhances the tensile and shear strength of the panel 13.

It will be appreciated that depending on whether the source of water originates above or below the level of the insulation panel 13, the water repelling sheet 28 could be attached to the top surface 124, and the non-woven wicking sheet 16 could be attached to the bottom surface 126 instead of as illustrated.

When the thermal insulation panels 13 are interlocked, the subsurface insulation product is formed which provides a comprehensive thermal and moisture barrier and which is resistant to breakage due to its robust notched shiplap edges.

Referring to FIGS. 1(b) and 2, one method of reducing ground disturbance during freeze-thaw cycles using the second embodiment of the subsurface insulation product includes excavating soil 10 from an affected area 12 that has been affected by ground disturbance due to subsurface flow and subsequent freezing of water. A plurality of the insulation panels 13 are then laid over the affected area 12, thereby thermally insulating the affected area 12 from freezing. Referring to FIG, 1(b), the surface of the board 14 having the wicking sheet 16 attached thereon is laid in a path of the subsurface flow of water. The foam board in each insulation panel 13 is provided to reduce the likelihood of freezing in the temperature ranges at which freeze-thaw cycles normally occur. The wicking sheet 16 of each insulation panel 13 serves to move water away from the affected area 12, so that there is less likelihood of ground disturbance should affected area 12 freeze.

While the above description has applied to installing the subsurface insulation product to protect ground infrastructures in areas having seasonal zones, the insulation product 100 can also be useful to protect ground infrastructure used in permafrost areas, namely to protect ground infrastructure from damage caused by permafrost thaw.

Such ground infrastructure includes gas production equipment on a wellsite (not shown). A method of installing the subsurface insulation product in such a permafrost wellsite is now described. First, the site is covered by bedding material (typically snow) to provide a uniform surface for laying down the thermal insulation panels 13. The side can be sloped downwards on about a 2% grade from the wellhead (not shown) to accommodate drainage. Then, the modular thermal insulation panels 13 are applied and interlocked together such that the panels 13 extend slightly beyond the desired protected zone. Then, appropriate cover such as frozen soil or plywood is added over the subsurface insulation product. The product will remain in place for the duration of the drilling and for resource extraction. Once the well is shut in, the top-fill is removed and the product can be extracted for reuse at other well sites, leaving the present site in a remediated state.

A method of installing the subsurface insulation product in a permafrost site having a surface pipeline is now described (but not shown). Such an installation avoids the use of refrigeration units on support foundations, which can drastically reduce operation and capital costs. The support foundation is installed by: (1) anchoring the foundation then excavating the piling area to the permafrost level, (2) installing thermally insulated pilings, (3) installing the subsurface insulation product by laying and interlocking the thermal insulation panels 13 over the permafrost soil (4) forming and pouring a concrete foundation, then (5) backfilling the perimeter of the foundation with native material. A pipeline corridor is installed by (1) stripping soil to the frost line, (2) installing the subsurface insulation product by laying and interlocking the thermal insulation panels 13, and then (3) replacing the surface soil. Use of the insulation product under the entire length of an elevated pipeline will allow the elevation of the pipeline to be substantially reduced as it will insulate the permafrost from heat radiated from the line load.

A method of installing the subsurface insulation product in a permafrost site having subsurface pipelines is now described (but not shown). First, a trench is excavated in conventional fashion to a level of permafrost soil. The insulation product is installed in the manner described above at the bottom of the trench. The sub-surface pipeline is then laid in a conventional manner and the trench is partially backfilled, conformed to the shape of the sloped insulation panels. More insulation product is laid on top of this partially backfilled material. Then the trench is completely backfilled and the process is completed.

A method of installing the subsurface insulation product in a permafrost site having a roadway is now described and shown in FIG. 1(a). First, overburden is removed until permafrost 11 is exposed. Then the insulation product is installed over the permafrost 11 in the manner described above. Then the insulation product 100 is covered with native soil fill 10. Finally, normal roadway construction procedures are undertaken to complete the roadway 18.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A subsurface thermal insulation product for reducing ground disturbance during a freeze-thaw cycle, comprising:
a plurality of thermal insulation panels each comprising:
a foam board, each foam board having a top surface and a bottom surface and four peripheral shiplap edges each with a notch that permits multiple thermal insulation panels to be placed in adjacent overlapping engagement; and
a water wicking sheet attached to one of the top surface or the bottom surface of the foam board.

2. The product as claimed in claim 1 wherein each thermal insulation panel further comprises a water repelling sheet attached to the other of the top surface and bottom surface of the foam board.

3. The product as claimed in claim 1 wherein the foam board has a composition selected from the group consisting of polystyrene and polyurethane.

4. The product as claimed in claim 3 wherein the foam board has a composition of high density expanded polystyrene (EPS).

5. The product as claimed in claim 1 wherein the foam board is between 3″ and 4″ thick and the notches are half the thickness of the board and have an overlap of between 2.7″ to 3.3″.

6. The product as claimed in claim 1 wherein the notches are ½ the thickness of the board and the ratio of board thickness to overlap is between 1.21:1 and 1.48:1.

7. The product as claimed in claim 6 wherein the notches have an overlap of 3″.

8-14. (canceled)
